(19) United States
(12) Patent Application Publication
(10) Pub. No.: US 2013/0320115 A1
(43) Pub. Date: Dec. 5, 2013

(54) SHUT-OFF FOR SPRAYERS

(71) Applicants: JOHN D. DELORME, SPENCERPORT, NY (US); RONALD M. ODESSA, BATAVIA, NY (US)

(72) Inventors: JOHN D. DELORME, SPENCERPORT, NY (US); RONALD M. ODESSA, BATAVIA, NY (US)

(21) Appl. No.: 13/871,501

(22) Filed: Apr. 26, 2013

Related U.S. Application Data
(60) Provisional application No. 61/639,561, filed on Apr. 27, 2012.

(51) Int. Cl. B05B 11/00

(52) U.S. Cl. CPC B05B 11/0064; B05B 11/0072
USPC 239/527

(57) ABSTRACT

A shut-off having a flexible diaphragm valve resting on a valve seat. The force of the pressurized liquid presented to the valve lifts the diaphragm valve and opens the shut-off, when a plunger biased to hold the valve against the valve seat is lifted by movement of a handle attached to the plunger. A mechanism is provided to assist the lift-off of the diaphragm valve to provide a positive mechanical lift-off force. Such mechanism may include a projection on the diaphragm valve which is captured in the plunger, or a spring captured in an opening of the valve seat via which pressurized liquid is presented to the diaphragm valve.

Priority is claimed to U.S. Provisional Patent Application No. 61/639,561, filed Apr. 27, 2012, which is incorporated herein by reference.

The present invention relates to sprayer apparatus, particularly to shut-off having a valve for controlling flow of pressurized liquid from the tank of a sprayer to the nozzle for spraying. The shut-off is a manually actuatable mechanism which effectively and reliably opening a flexible valve member, referred to herein as a diaphragm valve, to allow flow of the pressurized liquid under low pressure condition, and/or where the diaphragm valve must be made of material(s) with less than desirable flexibility, but which must to be compatible with the chemicals of liquids handled by sprayers so as to prevent undesirable degrading of the valve's performance over time.

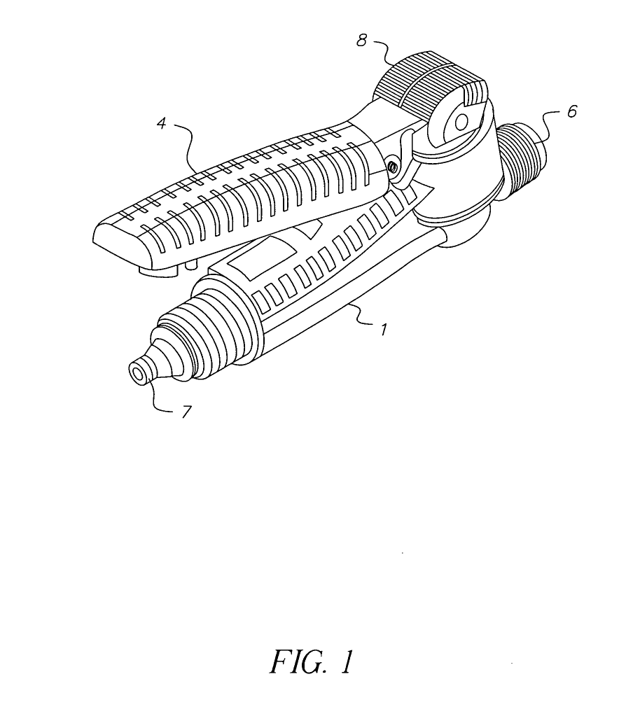

Shut-offs have been available which have a valve body through which the pressurized liquid for spraying flows. Such shut-offs commonly have a diaphragm valve in a chamber in the flow path through the body. FIG. 1 of U.S. Pat. No. 5,931,508, issued Aug. 3, 1999 to Clarke F. Spriegel, illustrates a shut-off. In such shut-off, a spring biased plunger keeps the diaphragm valve closed against a valve seat to prevent flow there through. The plunger is lifted off the diaphragm valve when a handle is rotated to enable spraying. Then, the pressure of the liquid vented against the diaphragm valve exerts a force which flexes the diaphragm valve away from the valve seat and allows the pressurized liquid to flow out of the shut-off to the nozzle of the sprayer.

Often harsh chemicals such as organic solvents (for example acetone) as well as corrosive chemicals and particles are present in the fluid from the sprayer. As a result, the diaphragm valve must be made of materials that can accommodate these harsh chemicals. Unfortunately such materials may not adequately flexible to provide a diaphragm valve that can properly flex to open the shut-off. Without sufficient flexibility the diaphragm valve may stick to its valve seat or may become permanently deformed, thereby negatively impacting the performance of the shut-off. In such cases, the pressure of the liquid which is presented to the side of the diaphragm valve facing the valve seat does not provide a sufficient force to reliably flex the diaphragm and open the valve when the shut-off is manually opened by rotating the handle of the shut-off. In other words, in addition to low pressure, the chemical composition of the spraying liquid is incompatible with the mechanical characteristics of the diaphragm valve of material(s) needed to accommodate harsh chemicals such as organic solvents as well as corrosive chemicals and particles when present in the fluid from the sprayer.

It is thus a principal feature of the present invention to provide a shut-off where the diaphragm valve of the shut-off must be made of materials which reduce its flexibility so as to be compatible with the chemistry of the liquids which may be handled by the sprayer, and/or a shut-off where the diaphragm valve capable of being opened effectively and reliably even under low pressure conditions.

It is another feature of the present invention to provide a shut-off which may be readily disassembled and reassembled for maintenance and replacement of elements, especially the flexible diaphragm valve thereof, which can wear in the course of operation of the shut-off.

Briefly described, the invention provides a manually operable shut-off for normally shutting off flow of pressurized liquid having a valve seat with an opening in communication with pressurized fluid, a diaphragm valve member disposed upon the valve seat, a plunger spring biased against the diaphragm valve to hold a surface of the diaphragm valve against the valve seat to close the opening of the valve seat to prevent the liquid from flowing there through, a handle coupled to the plunger to move the plunger away from the valve seat enabling the force of the pressurized liquid to move the diaphragm valve away from the valve seat and enable flow of the liquid through the opening of the valve seat, and a mechanism movable with the diaphragm valve for assisting the force of the pressurized liquid to move the diaphragm valve away from the valve seat when the plunger is moved away from the valve seat upon which diaphragm valve would otherwise rest upon.

The mechanism for assisting the force of the pressurized liquid may be provided by the diaphragm valve having a projection member attached to the plunger opposite the part of the diaphragm valve facing the opening of the valve seat so that a pull force is applied to the diaphragm valve flexing the diaphragm valve in a direction away from the valve seat. Such flexing of the diaphragm valve from movement of the plunger transferred to the diaphragm valve provides a positive mechanical lift-off force assisting the force of the pressurized liquid to flex the diaphragm valve away from the valve seat when the plunger is moved away from the valve seat and thereby open the shut-off. Preferably, the diaphragm valve is not permanently attached to the plunger, such as by the projection member having a head portion which is captured by a lip in an opening to a hole or cavity of the plunger sized to receive the head portion. The projection member's head portion is removable from the plunger's cavity to facilitate replacement of the diaphragm valve when needed.

The mechanism for assisting the force of the pressurized liquid may alternatively be provided by the valve seat having a spring sized to be received in the opening of valve seat in communication with fluid from the sprayer, where one end of the spring bears against the surface of the diaphragm valve so that the bias of the spring can apply a push force to the diaphragm valve in a direction away from the valve seat to flex the diaphragm valve when the plunger is moved away from the valve seat.

Such flexing of the diaphragm valve from force of the spring transferred to the diaphragm valve provides a positive mechanical lift-off force assisting the force of the pressurized liquid to flex the diaphragm valve away from the valve seat when the plunger is moved away from the valve seat and thereby open the shut-off. The spring in the valve seat through which the pressurized liquid thus applies a flexing and opening force to the diaphragm valve. The spring of the valve seat has insufficient strength to flex the diaphragm valve when the diaphragm valve is biased by the plunger to a closed position to shut-off the flow, but when the plunger is lifted off the diaphragm valve is mechanically assisted in flexing and thereby opening the shut-off so that the pressurized fluid can flow to the nozzle. Bias of the spring in the valve seat's opening cannot overcome the bias of the plunger against the diaphragm valve. Preferably, a protrusion in the surface of the diaphragm valve extends partially into the opening of the valve seat and is received into one end of the spring to position the spring with respect to the diaphragm valve. Thus, the diaphragm member is not permanently attached to such spring so as to facilitate replacement of the diaphragm valve when needed with disassembly of the shut-off. Optionally, both the spring in the valve seat and the above described projection member may be provided in the same shut-off.

Thus, the present invention overcomes these problems of incompatibility of material and mechanical characteristics in shut-offs by providing mechanical assistance to the diaphragm valve in opening when the force biasing the diaphragm valve to close position is removed, as when the handle lever is pivoted to effect opening of the shut-off. The present invention provides a mechanism movable with the diaphragm valve away from the valve seat when the plunger holding the diaphragm valve against the valve seat is lifted away from the diaphragm valve. This mechanism enables diaphragm valves having the requisite chemical resistance characteristics be used or the presence of low pressure of the spraying liquid, and nevertheless provide reliable and effective operation.

Further, the diaphragm valve can readily be removed together with other parts of the shut-off which are subject to wear and may need replacement due to the absence of a permanent connection between the diaphragm valve and the mechanism which assists it in opening for spraying operations.

The foregoing and other objects, features and advantages of the invention will become more apparent from a reading of the following description in connection with the accompanying drawings when:

FIG. 1 is a perspective view of a shut-off in which the diaphragm valve of the present invention may be incorporated;

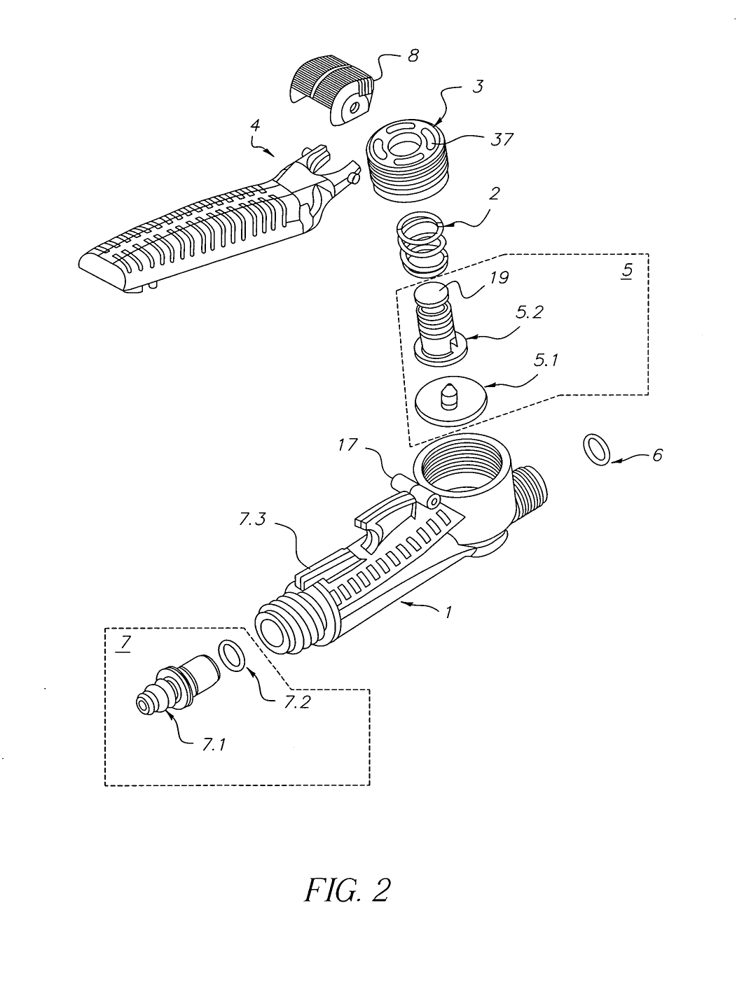

FIG. 2 is an exploded view of the shut-off shown in FIG. 1;

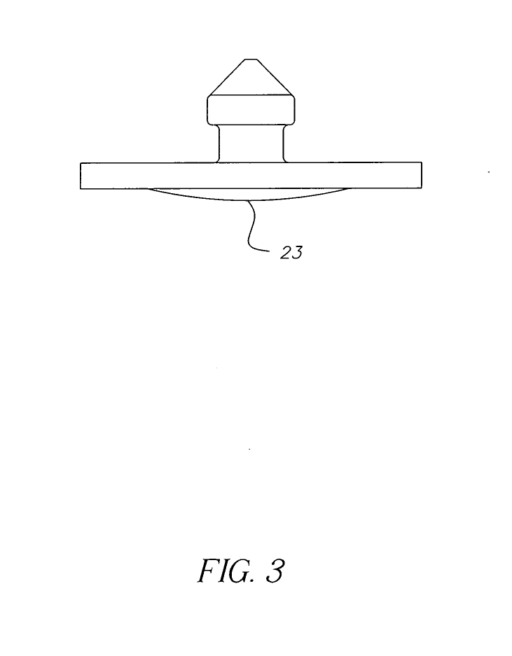

FIG. 3 is a front view of the diaphragm valve used in the shut-off shown in FIGS. 1 and 2 in accordance with one embodiment of the invention;

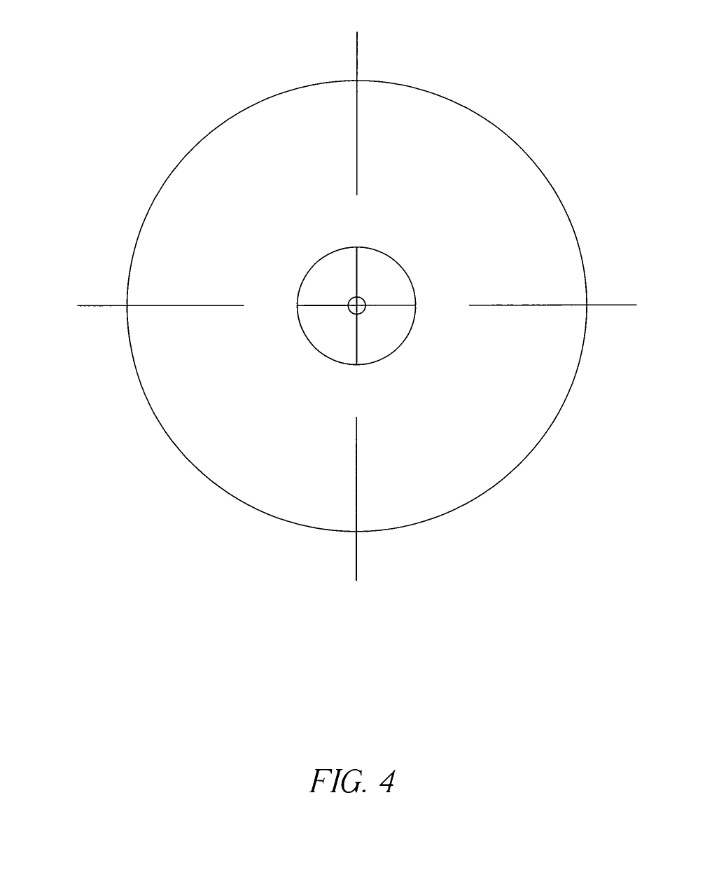

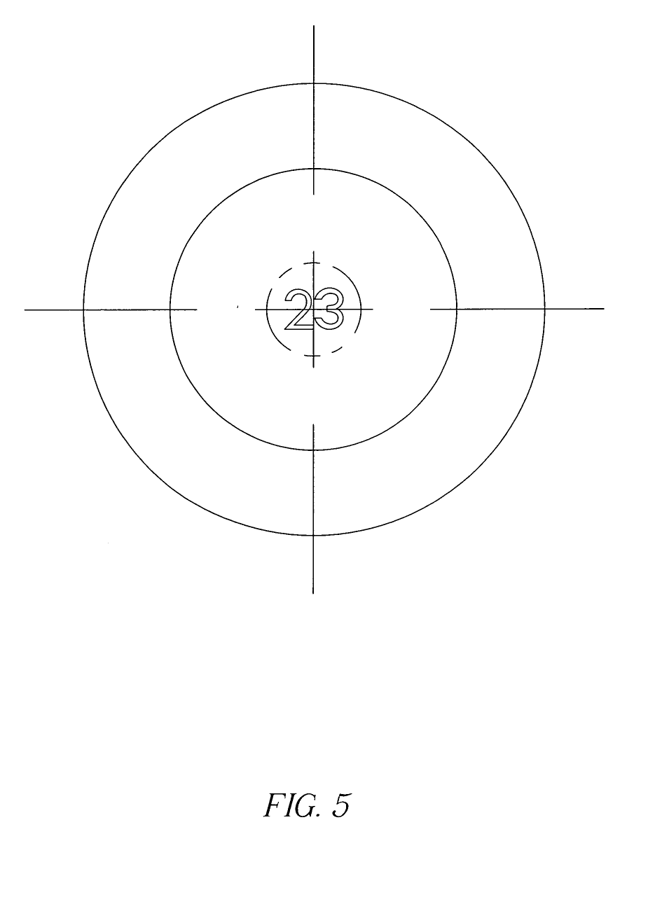

FIGS. 4 and 5 are, respectively, top and bottom views of the diaphragm valve shown in FIG. 3;

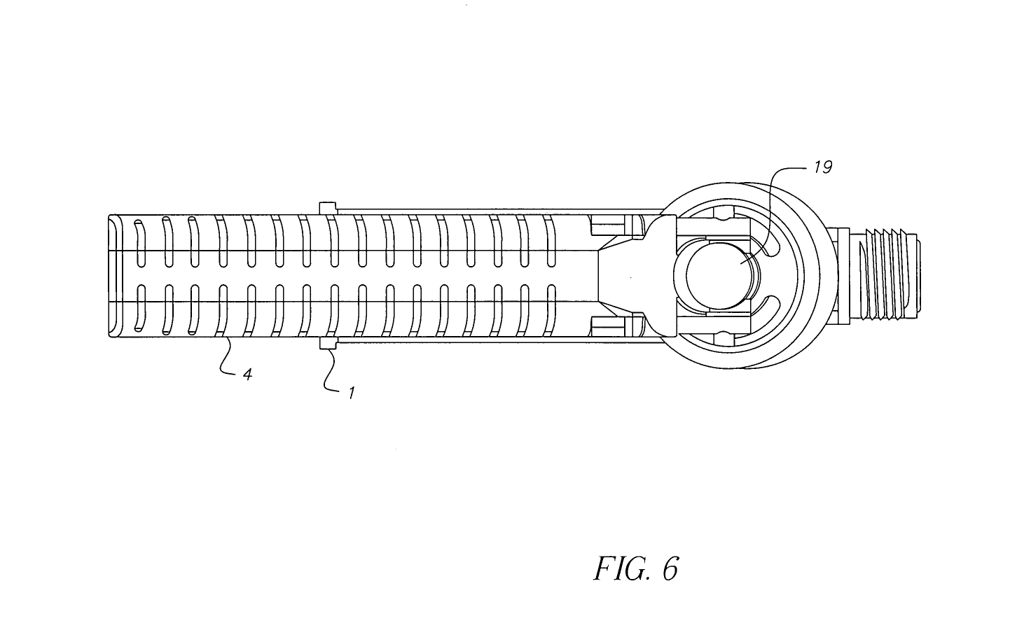

FIG. 6 is a plan view of the shut-off in FIG. 1, but with the shut-off lock removed;

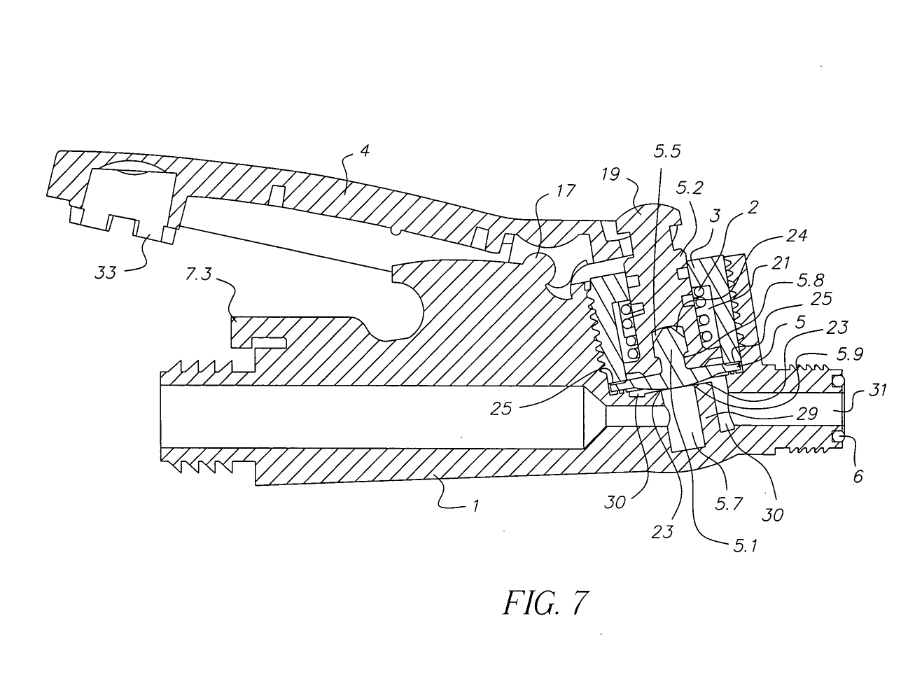

FIG. 7 is a sectional view taken along the line A-A of FIG. 6 and shows the shut-off illustrated in FIG. 2 in assembled condition; and

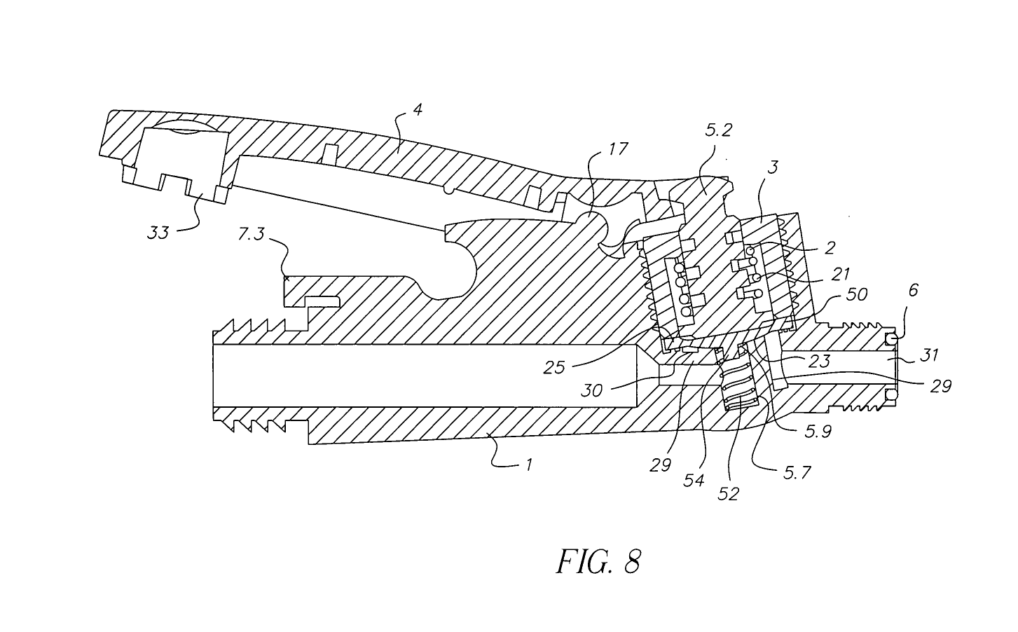

FIG. 8 is a sectional view along the longitudinal center of shut-off which is the same as shown in FIG. 7, but having an assistance mechanism for the shut-off in accordance with another embodiment of the invention.

The purpose and general design of the shut-off is the same as shown in the above-identified Spriegel patent. For example, the O-ring assembly shown at 7, 7.1 and 7.2 in FIG. 2 is the same as shown as shown at 30 at FIG. 1 of the Spriegel patent. The input hose 12 of the identified Spriegel patent and the output hose to the wand and nozzle is not shown in the drawings of this application. A full and complete description thereof may be found in connection with items 12, 14 and 40 of Spriegel patent, which accordingly is herein incorporated by reference. Latching member at 54 of FIG. 1 in the Spriegel patent is illustrated at 7.3 in FIGS. 2, 7 and 8. As shown in the drawings, the shut-off may have a molded plastic body 1 through which the pressurized fluid flows from left to right as shown in FIGS. 7 and 8.

The shut-off has an operating lever or handle 4 pivotally mounted on the body 1 at a pivot 17. This handle 4 engages the underside of a top cap 19 of a plunger 5.2. This plunger 5.2 is biased by a spring 2 against a diaphragm valve 5. Spring 2 is captured in a retainer cup 3 which is screwed into a cylindrical valve chamber 21 of the body 1. The diaphragm valve 5 has the shape shown in FIGS. 3, 4 and 5 which is a generally disc or washer shape.

Diaphragm valve 5 preferably is made of material compatible with the pressurized liquid which is controlled by the shut-off and may have a durometer representing the flexibility of such compatible materials. For example, the materials may be compatible with organic solvents such acetone or acetic substances. The material for acid resistance may be a copolymer of TFE and Polypropylene (or AFLAS). Another material for diaphragm valve 5 which is used to provide resistance to solvents is ethylene propylene diene monomer rubber (or EPDM). Other materials for diaphragm valve 5 which may be used are Viton and Nitrile. The flexibility of these materials vary, but should be selected to be compatible with harsh chemicals often present in the fluid from a sprayer tank. For example, Nitrile material provides flexibility for the thickness of the diaphragm valve of 50-65 Shore A Durometer. The other materials may have flexibilities of 60-65 Shore A Durometer.

In order to provide a valving effect, diaphragm valve 5 is flexed by engaging the curved bottom surface 23 thereof with the valve seat 29. The valve seat 29 is a part of the body 1 and has opening 5.7. The top end 5.9 of opening 5.7 faces a central portion of diaphragm valve 5. Opening 5.7 extends in the valve seat 29 to a closed end to define a hole in the valve seat having an opening in communication with fluid from a sprayer tank when pressurized. Valve seat 29 is concentric with the diaphragm valve, namely the center of the diaphragm valve 5 disc. The bias of a spring 2 around the plunger 5.2 maintains the shut-off closed. When the handle 4 is pivoted downwardly towards the body 1, plunger 5.2 is lifted and the diaphragm valve 5 is flexed because the edges thereof are sealed and captured by the rim 25 at the bottom of the retainer 3 (see FIG. 7).

The assistance mechanism is to ensure the flexing and opening of the diaphragm valve 5 is provided by a projection (or projection member) 5.1 of the diaphragm valve. Projection 5.1 has a head portion 24 of a diameter which friction fits in an opening 5.5 of the plunger 5 extending into the plunger to provide a hole or cavity sized to receive head portion 24. There may be a lip 5.8 around the entry to opening 5.5, such as 1-3 mm less than the diameter of opening 5.5, to capture and releasibly retain, lock, or attach the projection's head portion 24 to plunger 5.2 when projection 5.1 is pushed into opening 5.5. Projection 5.1 is removable from opening 5.5 by pulling on the diaphragm valve 5 to facilitate replacement of the diaphragm valve when needed.

Since the edges of diaphragm valve 5 are held by the retainer 3, the lifting of the plunger 5.2 provides positive mechanical action to assist the pressure presented by the pressurized fluid in opening 5.7 of the valve seat 29 when opening of the shut-off is desired. The projection 5.1 applies a force centrally to the bottom surface 23 of the lower side of the diaphragm valve 5. When the plunger is moved away from valve seat 29 against the bias of spring 2, the plunger 5.2 connection to the diaphragm valve projection 5.1 applies a pull (or positive lift off) force to the diaphragm valve flexing a central position of diaphragm valve in a direction away from the valve seat 29 and assists the force of the pressurized liquid (via opening 5.7) to flex the diaphragm valve 5 away from the valve seat 29, and thereby open the shut-off. Thus, positive assistance to the flexing of the diaphragm valve 5 is provided by the assistance mechanism. When the shut-off is open, the fluid flows from the opening 5.7 across the bottom of the diaphragm valve 5 to exit passageways 30 and 31. Passageway 31 is a circumferential slot which leads to the outlet passageway 30 and then to the outlet end 31 of the body 1. Disassembly of the shut-off is facilitated by a wrench 33 at one end of the lever handle 4 which engages slots 37 as shown in the retainer 3 of FIG. 2.

The shut-off lock is rotatable on the handle 4 and has an edge which enters underneath the cap 19 to hold the cap up and open when the handle 4 is pivoted downward toward the body 1.

Referring to FIG. 8, the shut-off, as illustrated, is like the shut-off shown in FIG. 7. The assistance mechanism is provided by the diaphragm valve 50 which has a shape somewhat different from the diaphragm valve 5. The diaphragm valve 50 is of material similar to that which may be used for the diaphragm valve 5 and thus has the same problems of flexing under low pressure and sticky conditions which may result from the chemical composition of the liquid to be sprayed. As stated earlier, opening 5.7 extends in the valve seat 29 to a closed end to define a hole in the valve seat having an opening in communication with fluid from a sprayer tank when pressurized. The mechanism includes a spring 52 extends in the hole provided by opening 5.7 in the valve seat 29 which is normally closed by the diaphragm valve 50 by plunger 5.1 under bias of spring 2. The diaphragm valve 50 may have a projection (or protrusion) 54 extending into opening 5.7 in order to maintain the spring in the opening 5.7 aligned centrally with the diaphragm valve 50.

Spring 52 diameter is slightly less than opening 5.7 of valve seat 29, where the upper end of spring 52 bears against the surface 23 of the diaphragm valve 50 so that the bias of the spring 52 can apply a push (or positive lift off) force to the diaphragm valve 50 in a direction away from the valve seat 29 to flex the a central position of diaphragm valve 5 when the plunger 5.2 is moved away from the valve seat 29 by downward movement of handle 4 in direction of body 1. Such flexing of the diaphragm valve 50 assists the force of the pressurized liquid via opening 5.7 to flex the diaphragm valve 50 away from the valve seat 29 to open the shut-off when desired.

The spring 52 has strength far less than the spring 2 which biases the plunger 5.2 against the diaphragm valve 50, and thus does not interfere with the action of the spring 2 in biasing the plunger 5.2 against diaphragm valve 50 so as to close diaphragm valve 50 at the rear or backside of diaphragm valve 50 from which the projection 54 extends. Accordingly, when and only when the lever handle 4 is pivoted so as to lift the plunger 5.2 does the spring 52 come into play to positively assist diaphragm valve 50 and deflect it in a direction away from the valve seat around the opening 5.7. In other words, the spring 2 is too weak to overcome the bias of the plunger 5.2 when the shut-off is closed, but when the shut-off is lifted, a positive mechanical force is applied by the spring 2 in the opening to flex the diaphragm and enable the pressurized liquid to flow past the diaphragm and out of the shut-off to a nozzle to initiate spraying.

From the foregoing description, it will be apparent that there has been provided improved shut-offs for sprayers provided which operate with special corrosive and environmentally adverse spraying liquids and under low sprayer liquid pressure. Variations and modifications in the herein described apparatus will undoubtedly suggest themselves to those skilled in the art. Accordingly, the foregoing description should be taken as illustrative and not in a limiting sense.

1. A manually operable shut-off for normally shutting off flow of pressurized liquid through a body having a valve chamber, a valve seat in said chamber, said chamber having an opening via which the pressurized liquid flows into the chamber, a flexible diaphragm valve between said diaphragm valve and said valve seat, said diaphragm valve presenting a surface to the force of the pressurized liquid in said opening in said valve seat, a plunger in said chamber bearing against said diaphragm valve to hold said diaphragm valve surface against said valve seat to close said valve and prevent the liquid from flowing through said body, a handle connected to said plunger moving said plunger away from said diaphragm valve and enabling the force of the pressurized liquid to move the diaphragm valve away from the valve seat and enable flow of the liquid through said body via said chamber, and a mechanism movable with said diaphragm valve for assisting the force of said pressurized liquid to move the diaphragm valve away from the valve seat when the plunger is moved away from the diaphragm valve.

2. The shut-off according to claim 1 further comprising a spring in the chamber around the plunger but biasing the plunger and the diaphragm valve therewith against the valve seat to shut-off the flow of the liquid.

3. The shut-off according to claim 1 wherein said diaphragm valve has an edge sealingly connected to said body to seal said valve chamber between said diaphragm valve and said valve seat.

4. The shut-off according to claim 1 wherein said diaphragm valve is a disc of elastomeric material selected to be compatible chemically with the liquid.

5. The shut-off according to claim 4 wherein the material of the diaphragm valve is selected from acid resistant material such as AFLS, or EDPM or Viton or Nitrile.

6. The shut-off according to claim 5 wherein said Nitrile has a thickness and chemistry providing a Shore A durometer of 55-60 and the other diaphragm valve materials have a thickness and density providing a flexibility represented by a Shore A durometer of 60-65.

7. The shut-off according to claim 1 wherein said mechanism is provided by a projection from the side of said diaphragm valve opposite to the side thereof on which the force of the pressurized liquid is presented, and said plunger having a hole therein, an end thereof facing said opposite side of said diaphragm valve, said diaphragm valve is attached to said plunger via said projection, said projection being removable from said hole to enable maintenance and replacement of the diaphragm valve.

8. The shut-off according to claim 1 wherein said mechanism comprises a spring in a hole extending from said opening of said valve seat for biasing said diaphragm valve in a direction away from said valve seat, said spring in said hole having a strength sufficient to flex said diaphragm valve away from said valve seat when the plunger is moved away from the diaphragm valve.

9. The shut-off according to claim 8 wherein the mechanism includes a projection on the side of the diaphragm valve facing the hole, and movably disposed in said spring in said hole, sufficiently long to enter said spring in the hole and maintain the spring therein aligned centrally of the diaphragm valve.

10. An apparatus for controlling pressurized fluid flow from a sprayer tank comprising:
a valve seat with an opening in communication with pressurized fluid;
a diaphragm valve disposed upon said valve seat;
a plunger spring biased against said diaphragm valve to hold a surface of said diaphragm valve against said valve seat to close said opening of said valve seat to prevent the liquid from flowing there through;
a handle coupled to said plunger to move said plunger away from said valve seat enabling the force of the pressurized liquid to move said diaphragm valve away from said valve seat and enable flow of the liquid through said opening of said valve seat; and
means for moving said diaphragm valve for assisting the force of the pressurized liquid to move said diaphragm valve away from said valve seat when said plunger is moved away from said valve seat.

11. The apparatus according to claim 10 wherein said means further comprises a projection member extending from said diaphragm valve attached to said plunger opposite a part of said diaphragm valve facing said opening of said valve seat to enable application of a pull force to said diaphragm valve flexing said diaphragm valve in a direction away from said valve seat when said plunger is moved away from said valve seat.

12. The apparatus according to claim 10 wherein said means further comprises a spring sized to be received in said opening of valve seat in communication with fluid from said sprayer, wherein one end of said spring bears against said surface of said diaphragm valve so that said bias of said spring applies a push force to said diaphragm valve in a direction away from said valve seat to flex said diaphragm valve when said plunger is moved away from said valve seat.
